(19) United States
(12) Patent Application Publication
(10) Pub. No.: US 2006/0267346 A1
(43) Pub. Date: Nov. 30, 2006

(54) Hydraulic power plant driven by gravity and buoyancy circulation

(76) Inventor: Tien-Chuan Chen, Cyonglin Township (TW)

Correspondence Address: John S. Egbert;Harrison & Egbert, 7th Floor, 412 Main Street, Houston, TX, 77002, US

(21) Appl. No.: 11/138,875

(22) Filed: May 27, 2005

(51) Int. Cl. F03B 13/00

(52) U.S. Cl. 290/54

(57) ABSTRACT

The hydraulic power plant driven by gravity and buoyancy circulation uses gravity and buoyancy circulation to draw the water to the water tower located at a high position. The water tower is an airtight container, which is installed with a slideway inside, and provided with one or more buoy inside for guidance and circulation of float and sink. The transmission rod, is affixed to the vertical slide stand inside the airtight container, so the buoys could drive and release transmission rods of the connectors during the float process, and the kinetic energy could be converted into mechanic energy. Sets of transmission rod drives a group of lift pumps by coordinating with the reverse linking device and repeated synchronization, so that the water tower becomes a pressure conductor and supplies water to the overflow pipe. The water tower provides high efficiency and power generation capacity with height-based water reservoir.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a hydraulic power plant driven by gravity and buoyancy circulation, and more particularly to a gravity and buoyancy circulation using the buoyancy generated by air filled buoy in the airtight container and the gravity generated by water filled buoy, which converts the kinetic energy into mechanical energy to drive a group of lift pumps by coordinating with repeated synchronization to supply water to the airtight container continuously, so that the water tower, which is already filled with water, becomes a pressure conductor (Pascal's Principle) and supplies water to the overflow pipe, which is equipped with a check valve on the top, makes up the water tower driven by gravity and buoyancy; therefore, the water tower provides high efficiency and power generation capacity with height-based water reservoir.

### BACKGROUND OF THE INVENTION

There are many ways to generate electricity today, among these, thermal power, hydraulic power and nuclear power are the common ones, and power generated by thermal and nuclear power are being used most. However, neither of them is reusable energy, nor even though these non-reusable resources such as coal, oil and liquefied nature gas can generate the energy fast and effectively and covert it into electrical power, but with it being widely used today, these non-reusable energies will be used up completed in a near future. Furthermore, the environmental awareness gradually increases, and even though these non-reusable energies can be converted into the electrical power, nevertheless, it is harmful to the environment. Therefore, many domains that use non-reusable energy sources gradually use reusable energy, and the ways to generate electricity are gradually replaced with solar energy, wind, tide and sea current. However, with the limitations and restrictions such as climate, topography and geographical location, therefore, these reusable energies cannot be widely applied in different geographical environments.

Thus, to overcome the aforementioned problems of the prior art, it would be an advancement if the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

The present invention mainly provides a hydraulic power plant driven by gravity and buoyancy circulation, which uses gravity and buoyancy circulation to draw the water to the water tower A located at a high position, and the buoy 30 drives and releases transmission rods 50 51 during the float process repeatedly, which converts the kinetic energy into mechanic energy, and the set of transmission rod drives a group of lift pumps 70 by coordinating with repeated synchronization to supply water to the airtight container 10 continuously.

The water tower A, which is already filled with water, becomes a pressure conductor (Pascal's Principle) and supplies water to the overflow pipe 11, which is equipped with check valve 12 on the top; therefore, the water tower A provides high efficiency with height-based water reservoir.

The gravity and buoyancy circulation using the buoy 30 in the airtight container 10 makes up the water tower A driven by gravity and buoyancy.

The back end of the generator C can guide the water to the water pumping area D that is at the bottom of the airtight containers 10 in all water towers A, and the water inside the buoy 30 is drained out of the airtight container 10 through drain valve 34, and it can be guided back to the water pumping area D at the bottom of the airtight containers 10 in all water towers A, so that the hydraulic power is recycled continuously.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of a hydraulic power plant driven by gravity and buoyancy circulation of present invention.

FIG. 2 shows a disposition diagram of the inside of the water tower.

FIG. 3 shows a disposition diagram of the water tower in water pumping state.

FIG. 4 shows a disposition diagram of the inside details of the water tower.

FIG. 5 shows a state diagram of the buoy that is at the bottom of the airtight container of the water tower.

FIG. 6 shows a state diagram of the buoy that is at the bottom of the airtight container of the water tower.

FIG. 7 shows a state diagram of the air intake and water drainage of the buoy at the bottom of the airtight container at the bottom of the airtight container of the water tower.

FIG. 8 shows a state diagram of the buoy that is floating on the top of the airtight container of the water tower.

FIG. 9 shows a state diagram of the buoy that is fixed on top of the airtight container of the water tower.

FIG. 10 shows a state diagram of the air release and water inlet of the buoy on the top of the airtight container of the water tower.

FIGS. 11-13 show the state diagrams of the buoy floating vertically in the airtight container of the water tower.

FIGS. 14-15 show perspective state diagrams of the buoy that floats vertically with the transmission rod inside the airtight container of the water tower of the present invention.

FIGS. 16-17 show perspective state diagrams of the buoy that floats vertically with the lift pump inside the airtight container of the water tower of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

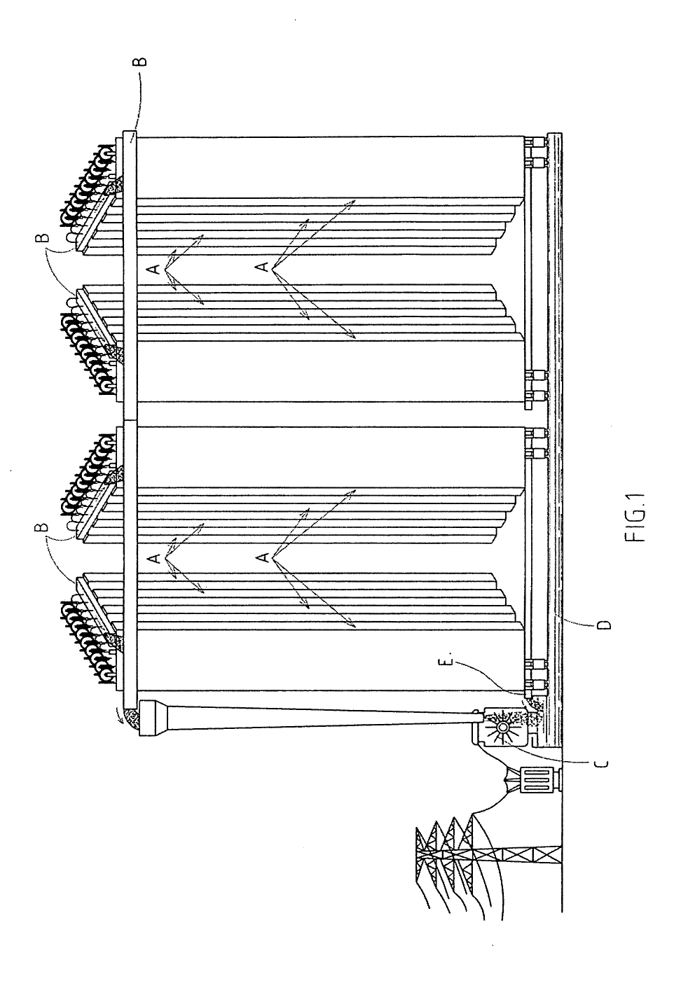

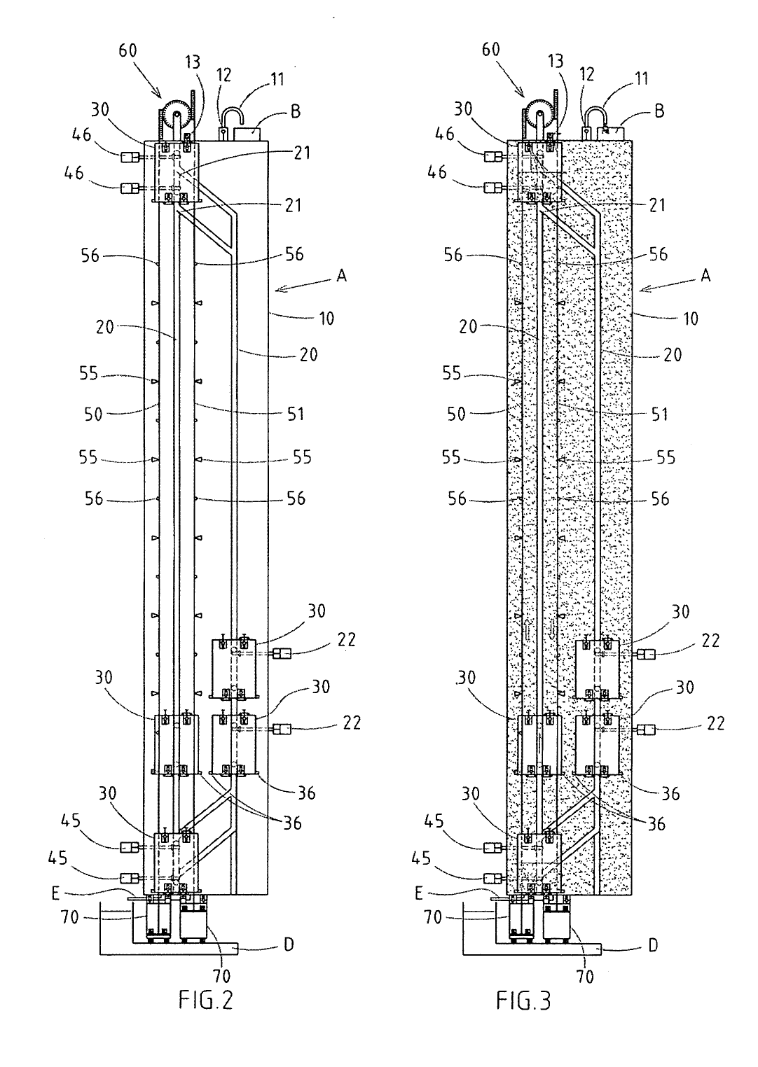

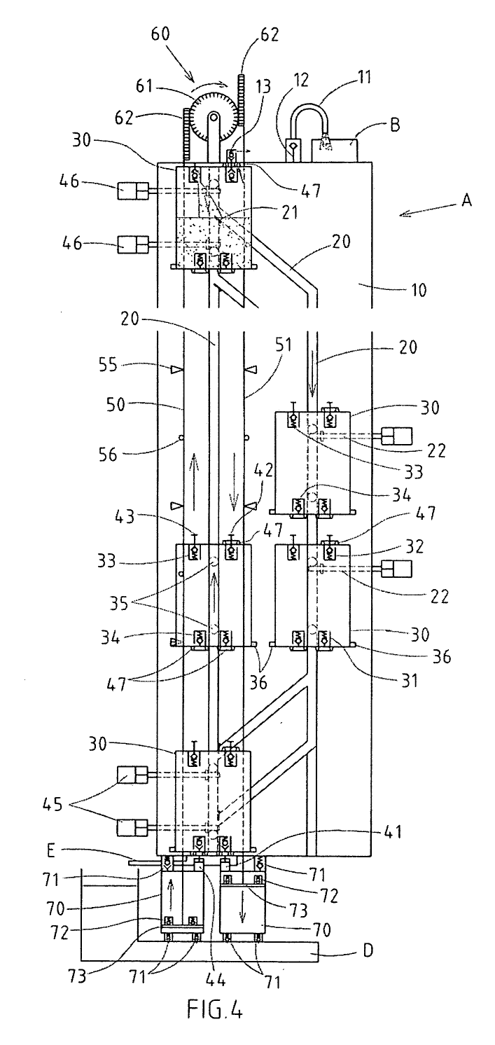

As shown in FIGS. 1-4, a hydraulic power plant driven by gravity and buoyancy circulation, which uses gravity and buoyancy circulation to draw the water to the water tower A located at a high position, and the water tower A comprises:

an airtight container 10, which has certain height, and is filled with water inside, and the overflow pipe 11 that is equipped with a check valve 12 and a check valve 13 is placed on its top;

a slideway 10, which is installed inside the airtight container 10, provides one or more buoys 30 for guidance and circulation of float and sink; among these, switch 21 and breaker 22 are placed at the area on the slideway 20 where the floating and sinking areas are connected, which provides directional and sectional guidance.

One or more buoys 30 are installed in the slideway 20 inside the airtight container with the symmetrical guides 35, and the wall of buoy is installed with intake valve 31, exhaust valve 32, inlet valve 33 and drain valve 34, and a set or more of linkage part 36 is placed on the protruding part of the wall.

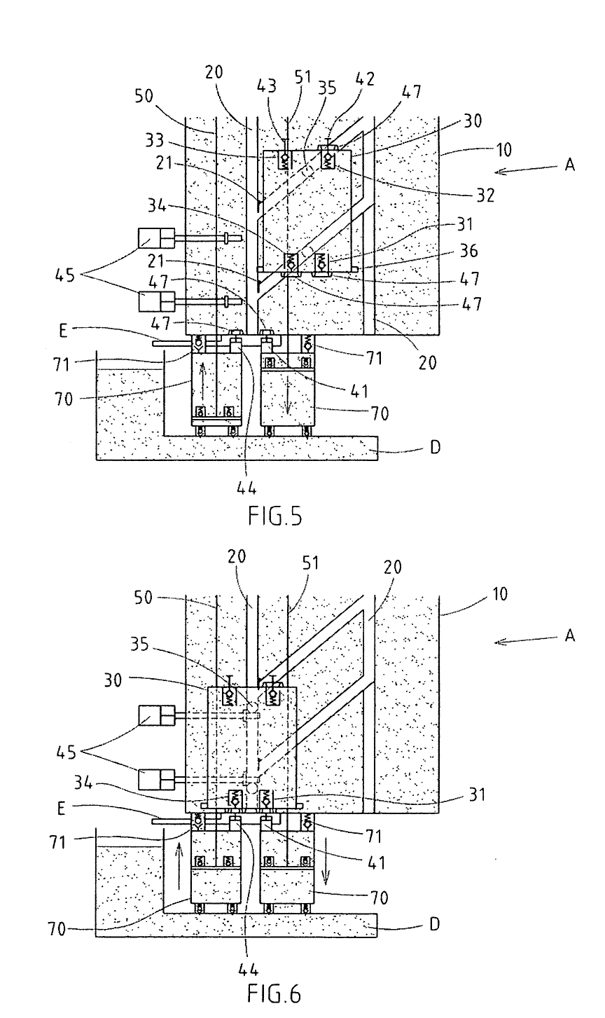

An intake module 41 and a drain module 44, as shown in FIGS. 5, 6, 7, are placed on the buoys 30 that are sunken on the bottom of the airtight container 10, can drive the intake valve 31 and the drain valve 34 separately to fill the buoy 30 with air through intake valve 31, and drain the water in the buoy 30 out of airtight container 10 through drain valve, among these, the buoy 30 that has water being drained and air being filled is fixed by a fixer 45, and a sealing component 47 is placed between the drain valve and intake valve between the buoy 30 and airtight container 10.

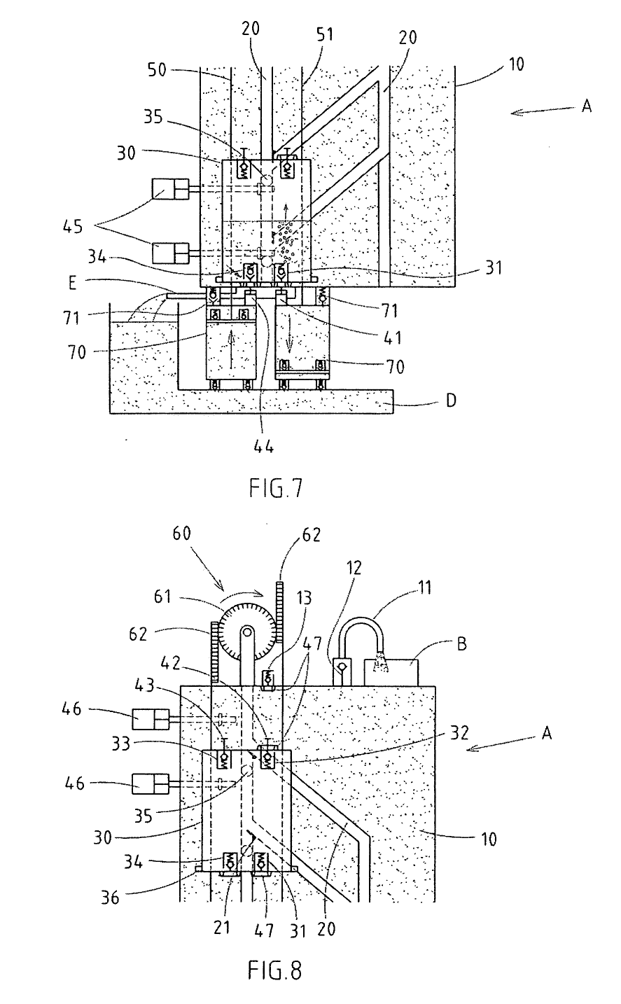

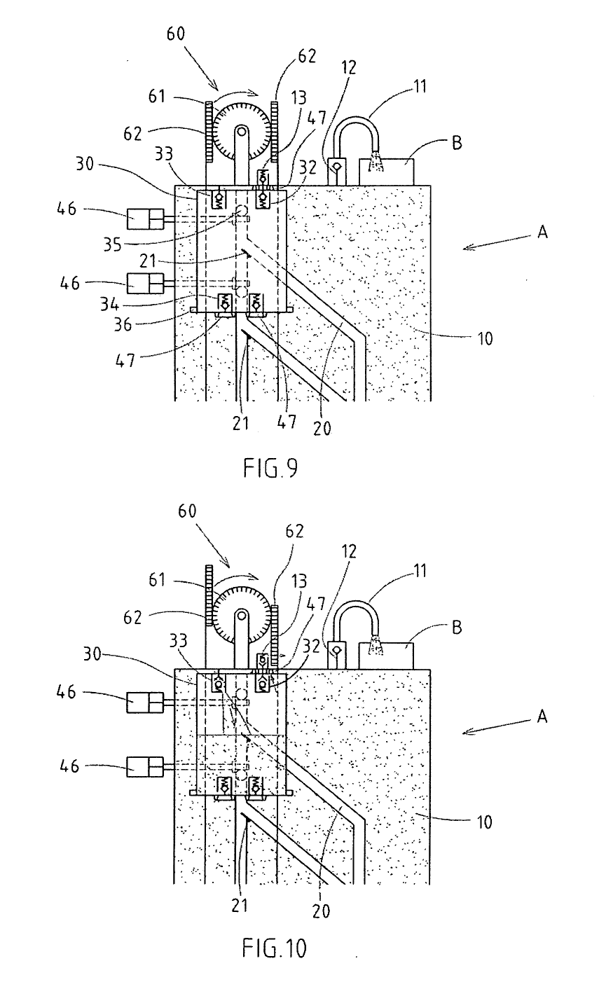

An exhaust component 42 and an inlet module 43, as shown in FIGS. 8, 9, 10, are placed on the buoy 30 that are floating on top of the airtight container 10, can drive the exhaust valve 32 and inlet valve 33 of the buoy 30, and the check valve 13 on top of the airtight container 10, so that the buoy 30 can be filled with the water through inlet valve 33 and has gravity, and the air in the buoy 30 is released out of the buoy 30 and airtight container 10 through exhaust valve 32 and check valve, among these, the buoy 30 that has air being drained and water being filled is fixed with a fixer 46, and the sealing component 47 is placed between the exhaust valve between the buoy 30 and airtight container 10.

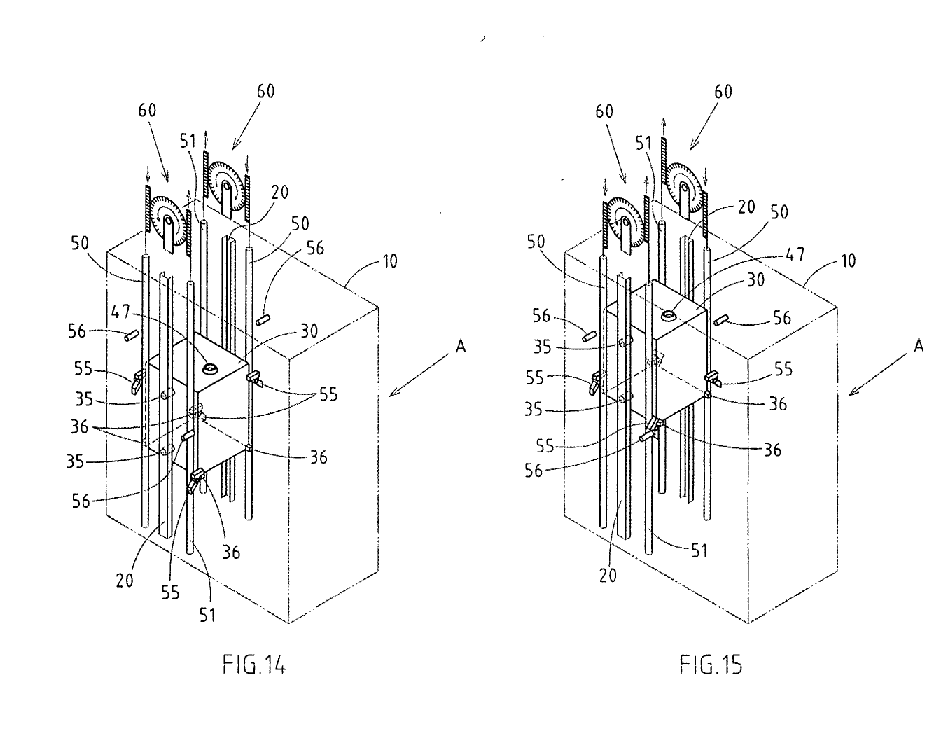

One or more sets of transmission rods 50 51 is affixed to the vertical slide stand inside the airtight container 10, corresponds to the linkage parts 36 on the outer wall of the buoy 30, and the connectors 55 that are placed on the transmission rod 50 51 in sections, which can be linked to the linkage part 36 of the buoy 30 that is on the floating path (as shown in FIGS. 14, 15).

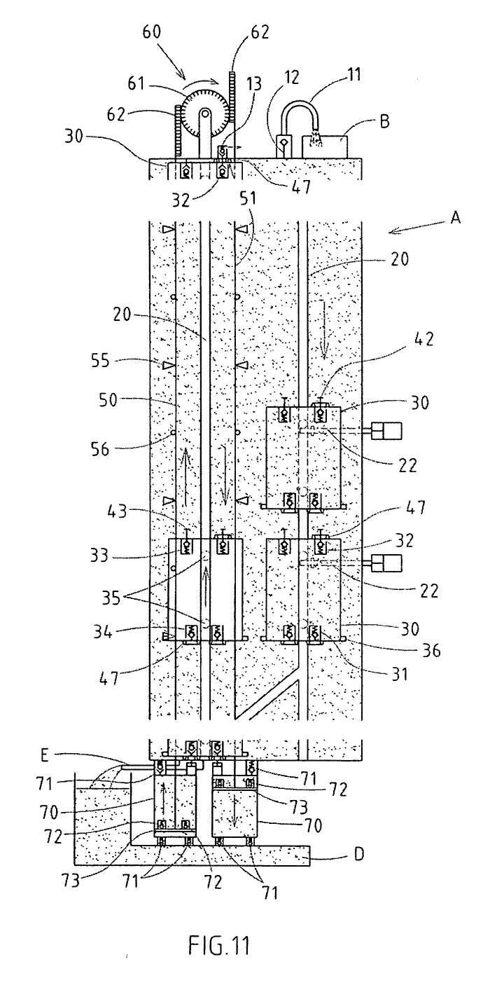

Several trippers 56 are installed inside the airtight container 10, and located about a lift pump length on top of the connector 55 that are on the transmission rod 50 51, as shown in FIGS. 11, 12, 13, move with the connector on the transmission rod 50 51, and it unlinks the connection between the connector 55 and the linkage part 36 of the buoy 30.

Several reverse linking devices 60 are installed in between the transmission rods 50 51, so that vertical slides of the neighboring set of the transmission rod 50 51 can be linked in reverse.

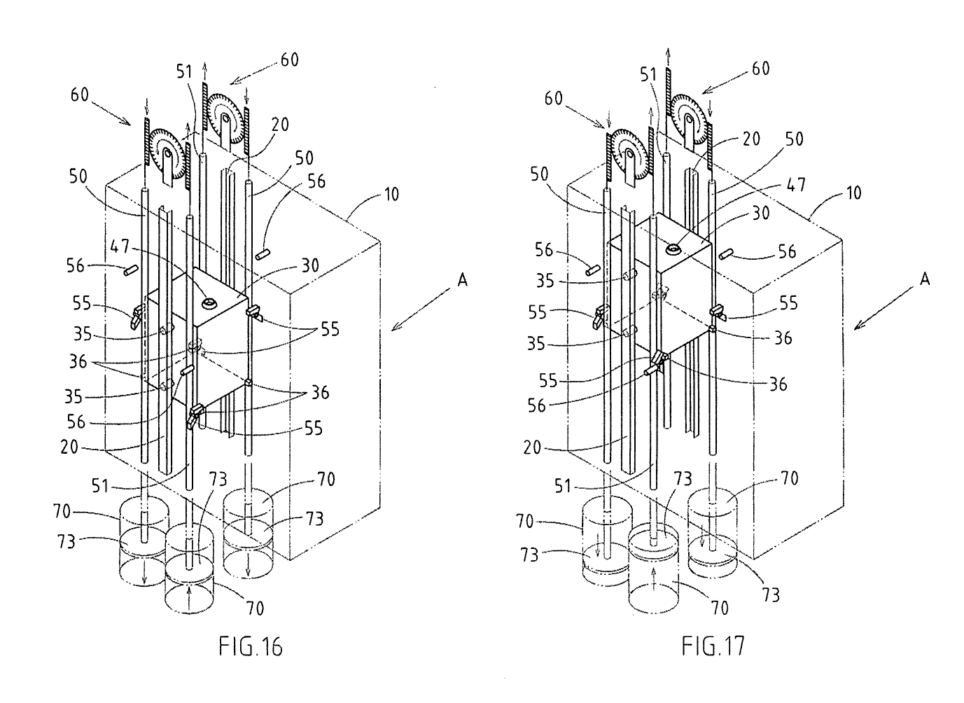

Several lift pumps 70 are installed at the bottom of the airtight container 10 and water pumping area D, and check valves 71 are placed at its connection, and each lift pump 70 has piston 73 that has check valve 72, which is driven repeatedly by sets of transmission rod 50 51 (as shown in FIGS. 16, 17).

The water tower A uses gravity and buoyancy circulation consists of parts mentioned above, mainly uses the buoyancy of the buoy 30 to create several vertical sliding movements by the corresponding transmission rod 50 51, and the sets of transmission rod drives a group of lift pumps by repeated synchronization to supply water to the overflow pipe 11, which is equipped with a check valve 12 on the top of the airtight container, and the buoy sunken on the bottom of the airtight container is operated for air inlet and water drainage, so that the buoy is filled with air and has buoyancy; and the buoy 30 floating on the top of the airtight container is operated for water intake and air release, so that buoy 30 is filled with water and has gravity; the gravity and buoyancy circulation using the buoy makes up the water tower driven by gravity and buoyancy, in which the accumulated water supply from the airtight container generated by the buoyancy of each buoy is definitely greater than that generated by the gravity of the buoy; therefore, the water tower A provides high efficiency and power generation capacity with height-based water reservoir.

As shown in FIG. 1, the several water towers A that use gravity and buoyancy circulation to draw the water to the water tower located at a high position are installed, and the water is gathered through overflow pipe 11, which is equipped with one way check valve 12, to the water gathering channel B, and is guided to the generator C to generate the electricity and supply power; and the water can be gathered again at the end of the generator C to be guided to the water pumping area D at the bottom of the water tower A of the airtight container 10 for recycling.

The buoy 30 that is in the airtight container 10 of the water tower A is filled with air through intake valve and has buoyancy, and the water inside the buoy 30 is drained out of the airtight container 10 through the drain valve, s that it may be guided to the water pumping area D located at the bottom of the airtight container 10 of the water tower A through return channel E for recycling.

As shown in FIGS. 11, 12, 13, several reverse linking devices 60 located on top of the airtight container 10 of the water tower A have two rows of gear rack 62 placed on both sides of a gear 61, and the two rows of the gear rack 62 are placed in between the transmission rods 50 51, so that vertical slides of the neighboring set of the transmission rod 50 51 can be linked in reverse (as shown in FIGS. 14, 15).

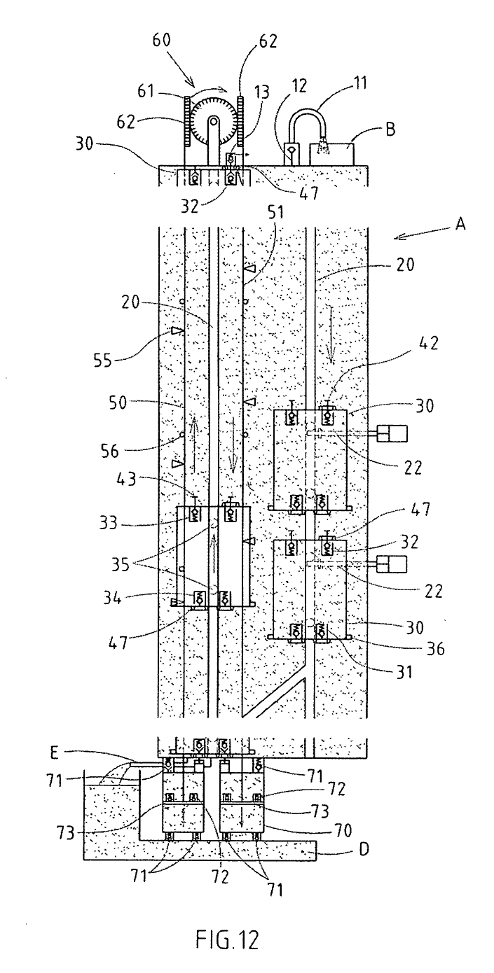

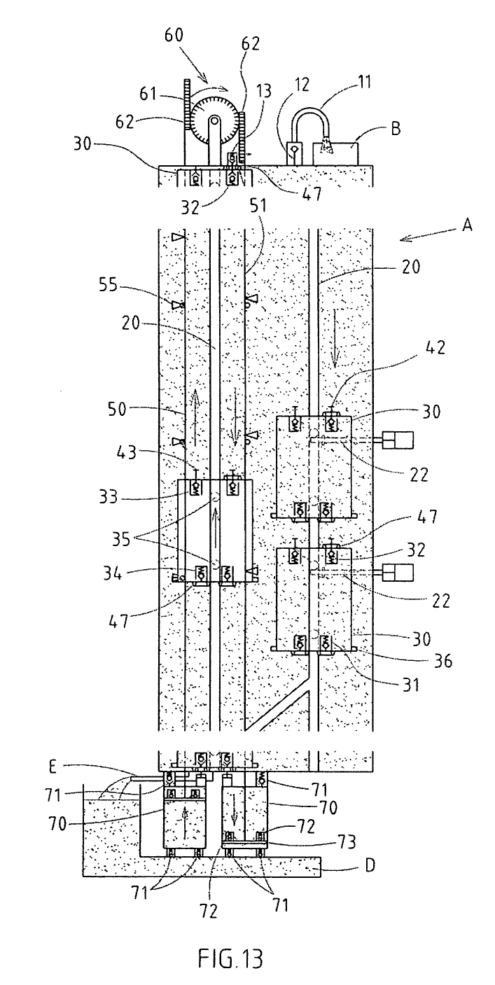

The actual use of the water tower A of gravity and buoyancy circulation of the present invention is to use the buoy 30 sunken on the bottom of the airtight container 10 after it is fixed by the fixer 45, as shown in FIG. 7, to drive the intake vale 31 and drain valve 34 of the buoy 30, so that the buoy is filled with air through intake valve 31 and has buoyancy, which releases the fixer 45, so that the buoy 30 can float up using the symmetric guides 35 along the slideway 20 in the airtight container 10, and corresponds with the linkage part 36 on the outer wall of the buoy on the floating path, (as shown in FIG. 11) to provide the linkage for the connector 55 that is placed on the transmission rod 50 in sections, and pulls a set of transmission rod 50 upward, and to drive the piston 73 of the set of the lift pump 70 upward to supply the water to the airtight container 10. At the same time, pump the water from the water pumping area D to the lift pump 70 (as shown in FIGS. 12, 13), and another set of the transmission rod 51 slides down vertically by the reverse linking device 60 to, drives the piston 73 of this set of lift pump 70 down, and to pump the water that is under the piston 73 of the lift pump 70 to the top of the piston 73.

Among them, the distant of the set of transmission rod 50 that is being pulled up by the buoy 30, as shown in FIGS. 11, 13, should be restricted to no more than the moving path of the piston 73 inside the lift pump 70; and the tripper 56 that is pre-installed in the airtight container 10 moves with the connector 55 on the transmission rod 50, which unlinks the linkage part 36 of the connector 55 and the buoy 30; at this time, another set of the transmission rod 51 slides down through linking device 60, and the connectors 55 that is placed on the transmission rod 51 in sections links to another set of linkage part 36 that is placed on the outside of the floating buoy 30, which pulls up a set of transmission rod 51 vertically, as shown in FIGS. 16, 17, and drives the piston 73 of this set of lift pump 70, to supply the water to the airtight container 10. At the same time, it pumps the water in the water pumping area D into the lift pump 70, and another set of the transmission rod 50 slides down through the reverse linking device 60, which drives the pistons of the lift pump 70 down, and pumps the water that is under the piston inside the lift pump 70 to the top of the piston 73.

Therefore, the set of transmission rod 50 51 drives a group of lift pumps 70 by coordinating with the repeated synchronization to supply water to the airtight container 10, and to the overflow pipe 11, which is equipped with check valve 12; When the buoy 30 floats to the top of the airtight container 10, and after fixing the buoy 30 that is at the bottom of the airtight container 10 with the fixer 46, as shown in FIG. 10, the exhaust valve 32 and inlet valve 33 of the buoy 30 is driven by the exhaust component 42 and the inlet module 43, so that the buoy 30 is filled with water and has gravity, and the position of the buoy 30 is released from the fixer 46, so that the buoy 30 slides down the slideway 20 by coordinating with the switch 21 at the fork of the slideway 20, so that the sinking buoy 30 takes off from the floating area to the sinking area; and at the end of slideway 20 in the sinking area has sections of the breaker 22, so that the sinking buoy 30 is sunk at the bottom of the airtight container 10 in order, and restore the buoyancy by the air inlet and water drainage operation.

The gravity and buoyancy circulation using the buoy 30 using the buoy makes up the water tower driven by gravity and buoyancy, in which the accumulated water supply from the airtight container 10 generated by the buoyancy of each buoy is definitely greater than that generated by the buoyancy; therefore, the water tower provides high efficiency and power generation capacity with height-based water reservoir.

With several water towers that use gravity and buoyancy circulation to draw the water to the water tower located at a high position, the water-gathering channel gathers plenty of water from the overflow pipe 11, which is equipped with one-way check valve 12, and to guide to the generator C, which generates electricity and supplies power.

1. A hydraulic power plant driven by gravity and buoyancy circulation, using gravity and buoyancy circulation to draw the water to a water tower comprising:
a water tower located at a high position;
an airtight container having a certain height, and being filled with water inside, and having an overflow pipe equipped with a check valve and a check valve placed on a top thereof;
a slideway installed inside the airtight container, having a buoy for guidance and circulation of float and sink; having, among these, a switch and breaker placed at the area on the slideway where the floating and sinking areas connect, providing directional and sectional guidance;
one or more buoys installed in the slideway inside the airtight container with the symmetrical guides, and the wall of buoy is installed with intake valve, exhaust valve, inlet valve and drain valve, and a set or more of linkage part is placed on the protruding part of the wall;
an intake module and a drain module placed on the buoys that are sunken on the bottom of the airtight container, can drive the intake valve and the drain valve separately to fill the buoy with air through intake valve, and drain the water in the buoy out of airtight container through drain valve, among these, the buoy that has water being drained and air being filled is fixed by a fixer, and a sealing component is placed between the drain valve and intake valve between the buoy and airtight container;
an exhaust component and an inlet module placed on the buoy that are floating on the top of the airtight container, can drive the exhaust valve and inlet valve of the buoy, and the check valve on top of the airtight container, so that the buoy can be filled with the water through inlet valve and has gravity, and the air in the buoy is released out of the buoy and airtight container through exhaust valve and check valve, among these, the buoy that has air being released and water being filled is fixed with a fixer, and the sealing component is placed between the exhaust valve between the buoy and airtight container;
one or more sets of transmission rods affixed to the vertical slide stand inside the airtight container, corresponds to the linkage parts on the outer wall of the buoy, and connectors are placed on the transmission rod in sections, which can be linked to the linkage part of the buoy that is on the floating path;
several trippers installed inside the airtight container, and located about a lift pump length on top of the connector that are on the transmission rod, move with the connector on the transmission rod, and it unlinks the connection between the connector and the linkage part of the buoy;
several reverse linking devices installed in between the transmission rods, so that vertical slides of the neighboring set of the transmission rod can be linked in reverse; and
several lift pumps installed at the bottom of the airtight container and water pumping area, and check valves are placed at its connection, and each lift pump has piston that has check valve, which is driven repeatedly be sets of transmission rod;
wherein the water tower, which uses gravity and buoyancy circulation mainly uses the buoyancy of the buoy to create several vertical sliding movements by the corresponding transmission rods, and the sets of transmission rod drives a group of lift pumps by repeated synchronization to supply water to the overflow pipe, which is equipped with a check valve on the top of the airtight container, and the buoy sunken on the bottom of the airtight container is operated for air inlet and water drainage, so that the buoy is filled with air and has buoyancy; and the buoy floating on the too of the airtight container is operated for water intake and air release, so that buoy is filled with water and has gravity; and gravity and buoyancy circulation using the buoy makes up the water tower driven by gravity and buoyancy, in which the accumulated water supply from the airtight container generated by the buoyancy of each buoy is definitely greater than that generated by the gravity of the buoy; therefore, the water tower A provides high efficiency and power generation capacity with height-based water reservoir.

2. The structure defined in claim 1, wherein said several water towers that use gravity and buoyancy circulation to draw the water to the water tower located at a high position are installed, and the water is gathered through overflow pipe, which is equipped with one way check valve, to the water gathering channel, and is guided to the generator to generate the electricity and supply power; and the water can be gathered again at the end of the generator to be guided to the water pumping area at the bottom of the water tower of the airtight container for recycling.

3. The structure defined in claim 1, wherein said buoy that is in the airtight container of the water tower is filled with air through intake valve and has buoyancy, and the water inside the buoy is drained out of the airtight container through the drain valve, so that it may be guided to the water pumping area located at the bottom of the airtight container of the water tower through return channel for recycling.

4. The structure defined in claim 1, wherein said several reverse linking devices located on top of the airtight container of the water tower have two rows of gear rack placed on both sides of a gear, and the two rows of the gear rack are placed in between the transmission rods, so that vertical slides of the neighboring set of the transmission rod can be linked in reverse.
